(19) United States
(12) Patent Application Publication
(10) Pub. No.: US 2012/0132087 A1
(43) Pub. Date: May 31, 2012

(54) Husk Removing Device

(76) Inventor: Kuen-Yan Chen, Taichung City (TW)

(21) Appl. No.: 13/298,827

(22) Filed: Nov. 17, 2011

(30) Foreign Application Priority Data
Nov. 25, 2010 (TW) 099222880

(51) Int. Cl. B02B 3/00

(52) U.S. Cl. 99/617

(57) ABSTRACT

A husk removing device includes a screen body having an inner surface and an outer surface, and formed with a plurality of protrusions, and a plurality of elongated holes extending through the inner and outer surfaces. Each of the protrusions includes a flat portion distal from the inner surface and having a peripheral edge, and a surrounding portion that extends and tapers from the inner surface to the peripheral edge of the flat portion. A height of the flat potion from the inner surface is not greater than 1 mm. Each of the elongated holes passes through the flat portion and the surrounding portion of at least one of the protrusions so as to form a pair of opposing first shaving edges at the flat portion and pairs of second shaving edges at the surrounding portion.

### CROSS-REFERENCE TO RELATED APPLICATION

This application claims priority of Taiwanese application no. 099222880, filed on Nov. 25, 2010.

### BACKGROUND OF THE INVENTION

1. Field of the Invention

This invention relates to a husk removing device.

2. Description of the Related Art

A husk removing device is provided in a rice milling machine, and is used to separate husks from brown rice through rubbing and shaving processes so as to obtain milled rice.

FIGS. 1 to 3 show a conventional husk removing device 1 disclosed in TW Utility Model no. 335737. The husk removing device 1 includes a screen body 10 in the form of a hexagonal column. The screen body 10 has an inner surface 11 and an outer surface 12, and is formed with a plurality of conical-shaped protrusions 15 protruding from the inner surface 11, and a plurality of elongated holes 14 extending through the inner and outer surfaces 11, 12, and intersecting the conical-shaped protrusions 15 so as to format least a pair of opposing sharp shaving edges 16 at each of the conical-shaped protrusions 15.

When passing through the husk removing device 1, brown rice 100 contacts and rubs against the conical-shaped protrusions 15, and is shaved by the shaving edges 16, thereby resulting in removal of husk 101 from the brown rice 100 so as to obtain milled rice 102. The removed husk 101 falls off through the elongated holes 14, thus separating the husk 101 from the milled rice 102.

However, the conventional husk removing device 1 has the following drawbacks. Because of the shape of each of the conical-shaped protrusions 15, the effective rubbing area of the same is relatively small, which results in a low husk-removing efficiency. Moreover, since the height (h1) from the tip of each of the conical-shaped protrusions 15 to the inner surface 11 is relatively large, the brown rice 100 and the milled rice 102 can not easily roll through the conical-shaped protrusions 15. In addition, since the height difference between two acute angles 161, 162, of each of the pair of the curved shaving edges 16 is relatively large, the brown rice 100 and the milled rice 102 are likely to be damaged by the acute angle of the curved shaving edges 16.

As shown in FIG. 4, TW Utility Model no. M291850 discloses a husk removing device including a screen body 9 that has an inner surface 92 and an outer surface 93, and that is formed with a plurality of protrusions 95 each of which includes a flat portion 951 and a surrounding portion 952 and protrudes from the inner surface 92, and a plurality of elongated holes 94 intersecting the protrusions 95 so as to form a pair of opposite first shaving edges 961 and a pair of second shaving edges 962.

In this TW Utility Model, although reduction of the distance between the flat portion 951 and the inner surface 92 is mentioned, a specific range for the distance is not mentioned. It should be noted that, when the distance between the flat portion 951 and the inner surface 92 is relatively large, the height difference between two acute angles of each of the pair of the second shaving edges 962 is increased, thereby resulting in the aforementioned rice damage. In addition, in this TW Utility Model, advantages attributed to decrease in the distance between the flat portion 951 and the inner surface 92 are not proven by specific examples.

### SUMMARY OF THE INVENTION

The object of the present invention is to provide a husk removing device in which a height of a flat portion from an inner surface is not greater than 1 mm.

According to the present invention, there is provided a husk removing device including a screen body having an inner surface and an outer surface, and formed with a plurality of protrusions and a plurality of elongated holes. Each of the protrusions includes a flat portion distal from the inner surface and having a peripheral edge, and a surrounding portion that extends and tapers from the inner surface to the peripheral edge of the flat portion. A height of the flat portion from the inner surface is not greater than 1 mm. The elongated holes extend through the inner and outer surfaces. Each of the elongated holes intersects one of the protrusions so as to form a pair of opposing first shaving edges at the flat portion and pairs of second shaving edges at the surrounding portion.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a perspective view of a conventional husk removing device;

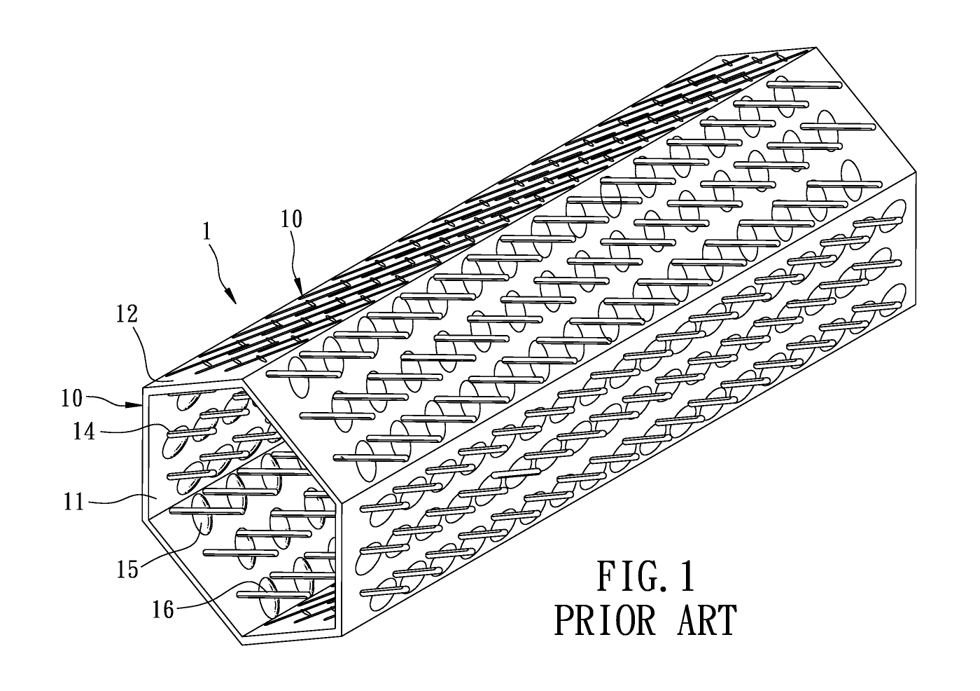

FIG. 2 is a fragmentary schematic view of the conventional husk removing device shown in FIG. 1;

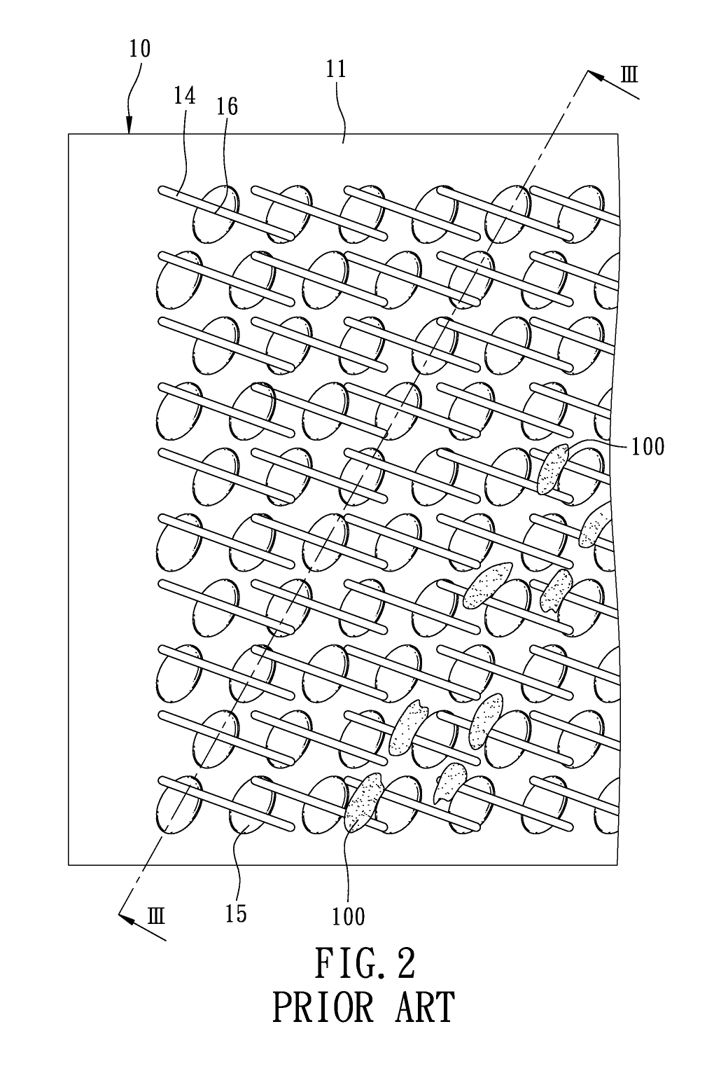

FIG. 3 is a cross-sectional view of the conventional husk removing device taken along line III-III in FIG. 2;

FIG. 4 is a cross-sectional view of another conventional husk removing device disclosed in TW Utility Model no. M291850;

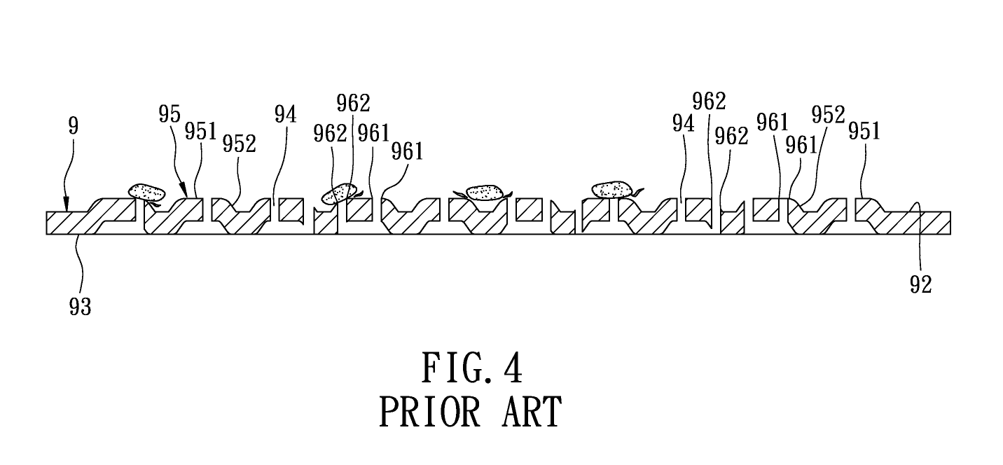

FIG. 5 is a schematic view of the preferred embodiment of a husk removing device according to this invention;

FIG. 6 is a fragmentary schematic view of the preferred embodiment shown in FIG. 5;

FIG. 7 is a fragmentary perspective view of the preferred embodiment shown in FIG. 5; and

FIG. 8 is a cross-sectional view of the preferred embodiment taken along line VII-VII in FIG. 6.

### DETAILED DESCRIPTION OF THE PREFERRED EMBODIMENT

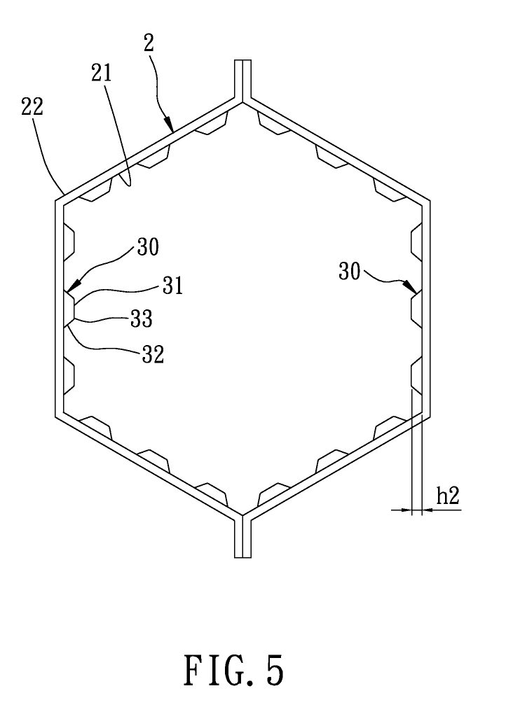

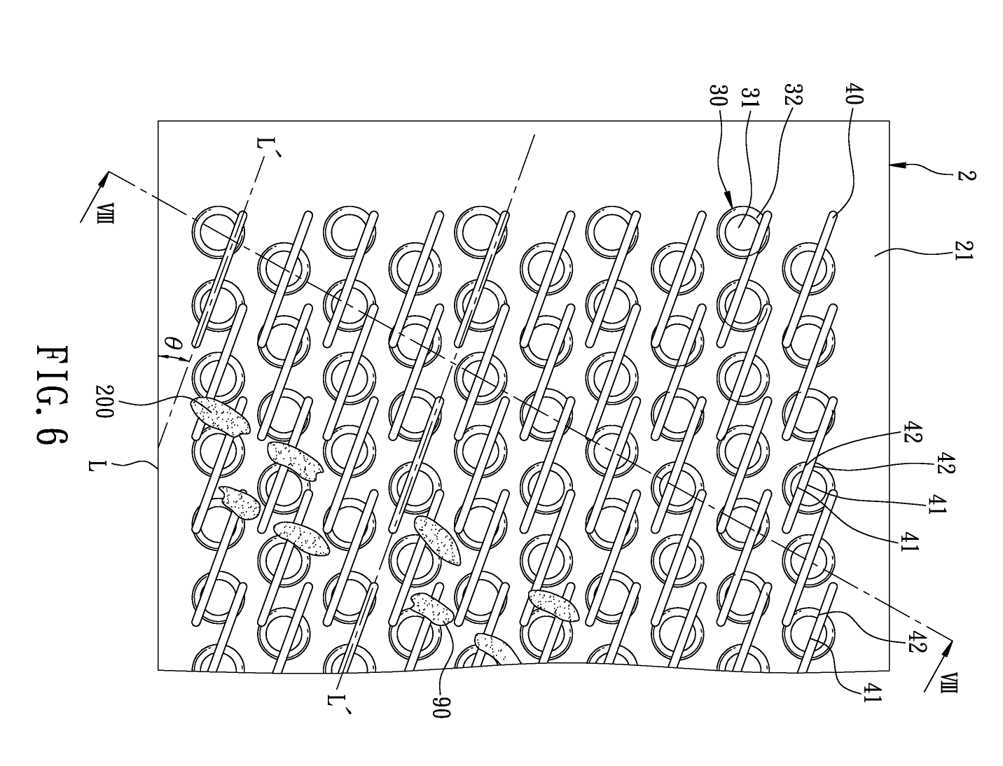

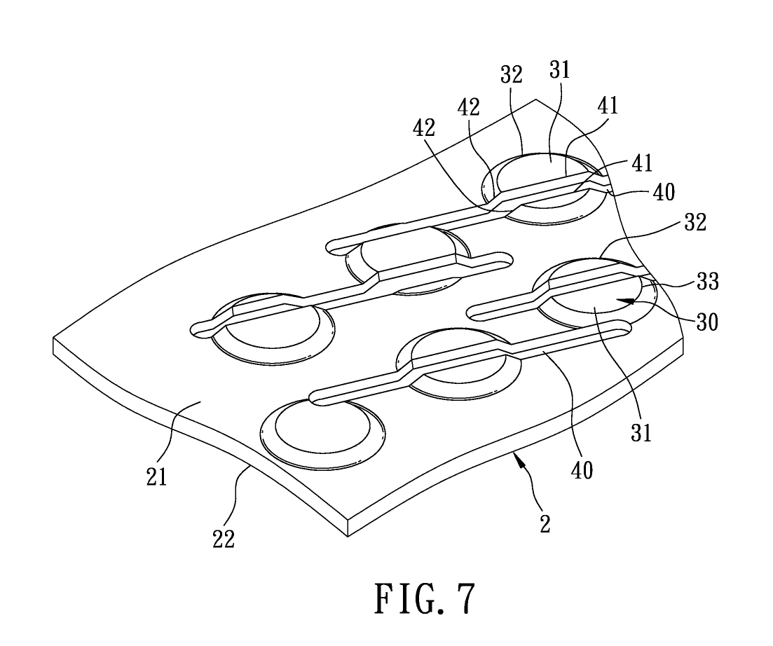

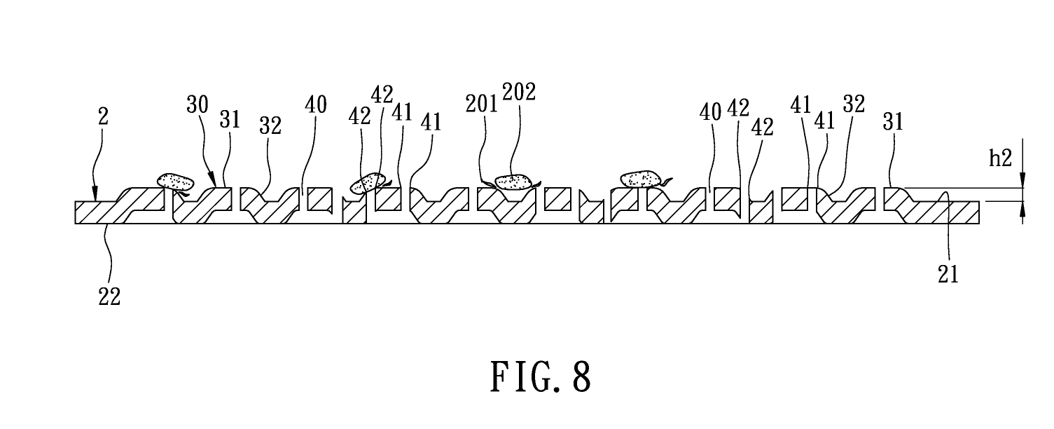

FIGS. 5 to 8 show the preferred embodiment of a husk removing device according to the present invention. The husk removing device comprises a screen body 2 having an inner surface 21 and an outer surface 22, and formed with a plurality of protrusions 30 protruding from the inner surface 21 and a plurality of elongated holes 40.

Each of the protrusions 30 includes a flat portion 31 distal from the inner surface 21 and having a peripheral edge 33, and a surrounding portion 32 that extends and tapers from the inner surface 21 to the peripheral edge 33 of the flat portion 31. The flat portion 31 has a height (h2) from the inner surface 21 not greater than 1 mm. The flat portion 31 of the protrusions 30 is formed by stamping process.

The elongated holes 40 extend through the inner and outer surfaces 21, 22. Each of the elongated holes 40 passes through the flat portion 31 and the surrounding portion 32 of at least one of the protrusions 30 so as to form a pair of opposing first shaving edges 41 at the flat portion 31 and two pairs of second shaving edges 42 at the surrounding portion 32.

In this embodiment, the screen body 2 is columnar in shape, has a hexagonal cross-section, and defines a longitudinal axis (L). The elongated holes 40 are elongated in a direction (L′) parallel to the inner surface 21, and are arranged parallel to each other. The elongated direction (L′) of the elongated holes 40 forms an acute angle with the longitudinal axis (L) of the screen body 2. Preferably, the acute angle is about 30°. The protrusions 30 are arranged in a plurality of parallel rows and are arranged in a stagger pattern, thereby guiding and raising the movement of the brown rice 90 in the husk removing device.

In this embodiment, the flat portion 31 of each of the protrusions 30 is circular and the surrounding portion 32 also has a circular cross section, i.e., each of the protrusions 30 has a truncated-conical shape. However, the shape of the flat portion 31 and the surrounding portion 32 could be varied based on actual requirements, e.g., the type or shape of the brown rice 90 to be milled. In addition, the shape of the screen body 2 is not limited to the disclosed embodiment. For example, the screen body 2 can be in the form of a plate.

In use, the brown rice 200 is directed into the husk removing device, and the husk removing device rotates, thereby driving the brown rice 200 to roll through the inner surface 21 of the screen body 2. Through the rolling movement, the brown rice 200 is shaved by the first and second shaving edges 41, 42, and rubs against the protrusions 30 so as to remove the husks 201 from the brown rice 200. After removing the husks 201 from the brown rice 200 through the rubbing and shaving processes, the removed husks 201 fall off through the elongated holes 40, thereby separating the husk 201 from milled rice 202.

### EXAMPLE

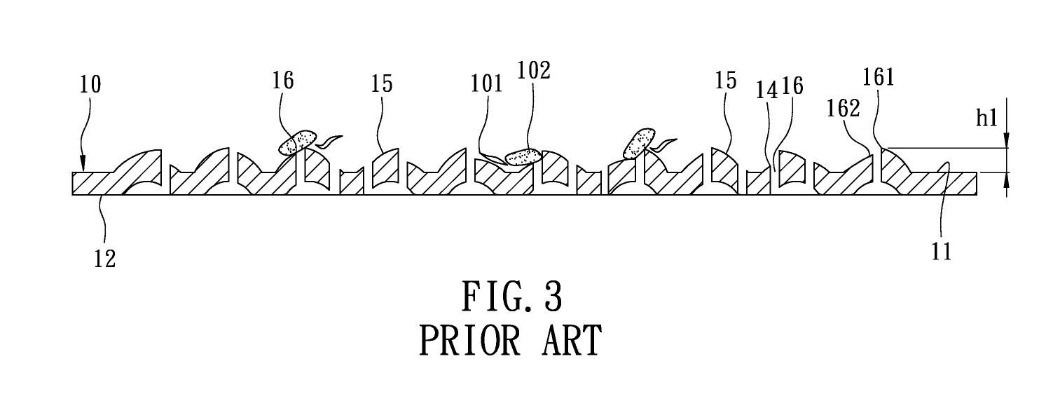

The husk removing device of the present invention having h2 of 1.0 mm and the conventional husk removing device (having a structure shown in FIG. 3 and h1 of 1.4 mm) were used to determine the differences of the husk-removing efficiency and the percentage of the damaged milled rice between the husk removing device of the present invention and the conventional husk removing device. In the example, the same amount of brown rice was supplied into the respective husk removing device at the same flow rate, and the milled rice thus produced was observed by naked eyes to determine the surface damage of the milled rice, e.g., scars on the milled rice, inferior luster of the milled rice, etc. The data is shown in Table 1.

TABLE 1

| | husk-removing | percentage of the |
|---|---|---|
| | efficiency | damaged milled rice |
| Conventional husk | 13% | 6% |
| removing device | | |
| (h1 = 1.4 mm) | | |
| The husk removing | 18% | 2% |
| device of this | | |
| invention | | |
| (h2 = 1 mm) | | |

As shown in Table 1, the husk removing device of this invention provides superior husk-removing efficiency and reduced percentage of the damaged milled rice.

Further, it is worth mentioning that the lifetime of the husk removing device of this invention is greater than that of the conventional husk removing device. To be specific, under the same operation condition, the service life of the husk removing device of this invention can be up to 3 months, and the service life of the conventional husk removing device 1 is about 1.5 months.

With the protrusion 30 having the flat portion 31, the husk removing device of this invention has a larger rubbing surface than that of the conventional husk removing device having the conical-shaped protrusion. In addition, by controlling the height (h2) of the flat portion 31 to be not greater than 1 mm, the undesirable damage to the milled rice 202 can be reduced, and the brown rice 200 and the milled rice 202 can more easily roll through the protrusions 30.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A husk removing device comprising:
a screen body having an inner surface and an outer surface, and formed with
a plurality of protrusions protruding from said inner surface, each of said protrusions including a flat portion distal from said inner surface and having a peripheral edge, and a surrounding portion that extends and tapers from said inner surface to said peripheral edge of said flat portion, a height of said flat portion from said inner surface being not greater than 1 mm, and
a plurality of elongated holes extending through said inner and outer surfaces, each of said elongated holes passing through said flat portion and said surrounding portion of at least one of said protrusions so as to form a pair of opposing first shaving edges at said flat portion, and pairs of second shaving edges at said surrounding portion.

2. The husk removing device of claim 1, wherein said screen body is columnar in shape and has a hexagonal cross-section.

3. The husk removing device of claim 1, wherein said flat portion of each of said protrusions is circular, said surrounding portion having a circular cross section.

4. The husks removing plate of claim 1, wherein each of said protrusions is formed by stamping process.
